(19) United States
(12) Patent Application Publication
(10) Pub. No.: US 2013/0019295 A1
(43) Pub. Date: Jan. 17, 2013

(54) METHOD AND SYSTEM FOR OPEN AUTHENTICATION

(71) Applicants: Sung-Jin PARK, Yongin-si (KR); Hong-Uk Woo, Seoul (KR); Kwan-Lae Kim, Suwon-si (KR); Soon-Hwan Kwon, Seongnam-si (KR)

(72) Inventors: Sung-Jin PARK, Yongin-si (KR); Hong-Uk Woo, Seoul (KR); Kwan-Lae Kim, Suwon-si (KR); Soon-Hwan Kwon, Seongnam-si (KR)

(73) Assignee: Samsung Electronics Co., Ltd., Suwon-si (KR)

(21) Appl. No.: 13/445,486

(22) Filed: Apr. 12, 2012

(30) Foreign Application Priority Data
Jul. 11, 2011 (KR) 10-2011-0068348

(51) Int. Cl. G06F 21/00; H04L 9/32

(52) U.S. Cl. 726/7

(57) ABSTRACT

Methods and apparatus for authentication are provided. A token request is received at a Web server from a third-party Web server. The third-party Web server is authenticated at the Web server. A token is issued to the third-party Web server. A user is authenticated based on the token issued to the third-party Web server. A token approval request is sent to a resource owner. A token approval or non-approval is received from the resource owner through a predefined channel.

### PRIORITY

This application claims priority under 35 U.S.C. §119(a) to a Korean Patent Application, which was filed in the Korean Intellectual Property Office on Jul. 11, 2011 and assigned Serial No. 10-2011-0068348, the entire disclosure of which is incorporated herein by reference.

### BACKGROUND OF THE INVENTION

1. Field of the Invention

The present invention relates to Open Authentication (OAuth), and more particularly, to a system for Application Programming Interface (API) authentication based on a Web service in order for a user and an owner to stably share a resource.

2. Description of the Related Art

HyperText Transfer Protocol (HTTP) can describe Web security using a World Wide Web (WWW)-Authentication and Authorization header part.

FIG. 1 is a ladder diagram illustrating an HTTP authentication procedure.

Referring to FIG. 1, in step 100, a client sends a request for a resource to a server through a GET command. In step 102, the server sends an authentication request to the client. In response to the authentication request, in step 104, the client provides an IDentification (ID) and password to the server. If it is determined that the client is valid, in step 106, the server provides a 200 OK code to the client, and informs the client of a transmission success without error.

Specifically, a Web server manages its own authorization realm, and a user combines an authority portion among Uniform Resource Locator (URL) elements of the Web server with the authorization realm of the server so that he/she may uniquely identify an authorization target. Also, in HTTP, it is recommended to use one of two extensible basic and digest authorization schemes, if possible. A structure in which a server manager entirely manages a license to a shared resource may use the HTTP authentication procedure of FIG. 1.

However, in recent social services, having an environment in which a server manager does not entirely manage the license to the shared resource and a service user manages the license to the shared resource himself/herself, the conventional HTTP authentication scheme it is not sufficient. Accordingly, modified versions of recently published OAuth standards have been extended so that they comply with an HTTP security scheme while the user may manage the license to the shared resource himself/herself. A plurality of Web services such as Google®, Yahoo®, Facebook®, Flicker®, Twitter® and the like are making use of OAuth or are making use of a unique authentication scheme similar to the OAuth. These schemes all extend HTTP and use a redirecting mechanism based on a token.

In OAuth, participants include, for example, a consumer that intends to use a resource, a user who provides a resource license, and a service provider who provides a relay service to the consumer or user. In the OAuth operation, the user grants only a restricted authority for a specific resource to the consumer without providing its own service ID and password to the consumer. As a result, the user safely manages the shared resource, and the service provider entrusts the user with a resource management authority and performs a proxy role.

For example, a user, who is a member of a service provider (e.g., a social networking site), may use a new Web service consumer. The consumer provides a function of sending gifts to social networking friends of the user. The consumer performs API license registration with the service provider beforehand. When the user visits the consumer, the consumer sends a request for token issuance to the service provider to bring a list of friends of the user. If a token is issued, the consumer redirects a social networking user authentication page to the user in compliance with a rule of generating a user authentication address of the service provider. If the user visits and logs into the user authentication page, the consumer makes a request for user authentication together with the guidance of requesting the friend list. If the user responds to this request, the token changes to a usable state and the service provider selectively redirects a current user authentication page to a callback address to which the consumer is registered, so that the user may continuously use the consumer. The consumer may attach the token approved by the user and get the list of social networking friends of the user from the service provider.

Web services providing OAuth or other token-based redirecting authentication schemes may safely realize a new Web service scenario by extending a security model of HTTP, but treat only a case where the user of the service provided by the consumer is the same as a user of the service provided by the service provider. Specifically, the user has the accounts of the consumer and the service provider, and the user approves of a different route accessing his/her own resource himself/herself.

However, there is no defined method for determining a resource license, when the user intends to get a list of friends of a third-party user (hereinafter, referred to as an ‘owner’) through the consumer.

### SUMMARY OF THE INVENTION

The present invention has been made to address at least the above problems and/or disadvantages and to provide at least the advantages described below. Accordingly, an aspect of the present invention provides a method and system for API authentication based on a Web service.

Another aspect of the present invention provides a method and system for stably sharing the resource when a user uses a Web resource of a different user who is a resource owner using a Web service (or application) of a third party, or a consumer.

According to one aspect of the present invention, a method for authentication in a Web server is provided. A token request is received from a third-party Web server. The third-party Web server is authenticated. A token is issued to the third-party Web server. A user is authenticated based on the token issued to the third-party Web server. A token approval request is sent to a resource owner. A token approval or non-approval is received from the resource owner through a predefined channel.

According to another aspect of the present invention, a method for authentication in a third-party Web server is provided. A service request is received from a Web-based user terminal. A token request is sent to a Web server in which a user has an account. An issued token is received from the Web server. An authentication Uniform Resource Locator (URL) of the Web server is created based on the issued token. The user is redirected to the authentication URL of the Web server.

According to a further aspect of the present invention, a method for authentication in a user terminal is provided. A third-party Web server is accessed for service initiation. The user terminal is redirected from the third-party Web server to an authentication URL of a Web server in which a user has an account. A log-in page is received from the Web server. User log-in data is forwarded to the Web server. When the user log-in data is valid, an inquiry about whether to approve a token from the Web server is received, and token approval is determined.

According to a yet another aspect of the present invention, a method for authentication in an owner terminal is provided. A token approval request notification is received through a predefined channel from a Web server in which an owner has an account, when a resource of the owner is requested by a third-party Web server. A license to the resource that is requested by the third-party Web server is checked. A response to the token approval request is transmitted to the Web server, based on the license to the resource.

According to a still another aspect of the present invention, a system for authentication is provided. The system includes a subscriber terminal for accessing a third-party Web server for service initiation via a service request, redirecting from the third party Web server to an authentication Uniform Resource Locator (URL) of a Web server in which a user has an account, performing authentication, receiving an inquiry about whether to approve a token from the Web server, and determining token approval. The system also includes the third-party Web server for receiving the service request from the user terminal, sending a token request to the Web server, receiving an issued token from the Web server, creating the authentication URL of the Web server based on the issued token, and redirecting the user terminal to the authentication URL of the Web server. The system further includes the Web server for receiving the token request, authenticating the third-party Web server, issuing the token to the third-party Web server, authenticating the user based on the token issued to the third-party Web server, sending a token approval request to a resource owner terminal through a predefined channel, and receiving a token approval or non-approval from the resource owner terminal. The system additionally includes the resource owner terminal for receiving a token approval request notification through the predefined channel from the Web server, checking a license to a resource requested by the third-party Web server, and transmitting the token approval or non-approval to the Web server in response to the token approval request.

### BRIEF DESCRIPTION OF THE DRAWINGS

The above and other aspects, features and advantages of the present invention will become more apparent from the following detailed description when taken in conjunction with the accompanying drawings in which:

FIG. 1 is a ladder diagram illustrating an HTTP authentication procedure;

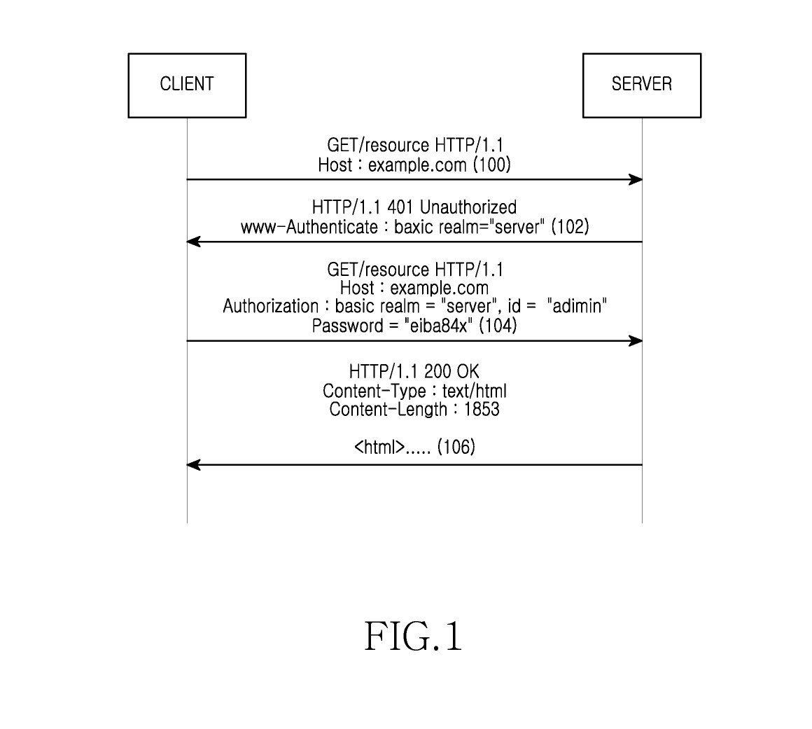

FIG. 2 is a diagram illustrating an authentication procedure, according to an embodiment of the present invention;

FIG. 3A is a diagram illustrating a service provider structure, according to an embodiment of the present invention;

FIG. 3B is a diagram illustrating a table structure of an AuthDb of FIG. 3A, according to an embodiment of the present invention;

FIG. 4 is a flowchart illustrating a token check procedure between a service provider and a user, according to an embodiment of the present invention;

FIG. 5 is a flowchart illustrating a token issuance procedure between a service provider and a consumer, according to an embodiment of the present invention; and

FIG. 6 is a flowchart illustrating a token approval procedure between a service provider and an owner, according to an embodiment of the present invention.

### DETAILED DESCRIPTION OF EMBODIMENTS OF THE PRESENT INVENTION

Embodiments of the present invention are described in detail with reference to the accompanying drawings. The same or similar components may be designated by the same or similar reference numerals throughout the drawings. Detailed descriptions of constructions or processes known in the art may are omitted to avoid obscuring the subject matter of the present invention. Terms described below, which are defined in considering the functionality of the present invention, may be different depending on user and operator intention or practice may.

A method and system for API authentication based on a Web service are described below, according to embodiments of the present invention.

In particular, embodiments of the present invention define a protocol capable of safely securing a process in which a user obtains approval of an owner of a shared resource using a third-party consumer Web service, in which a service provider acts as a proxy in the authentication.

The present invention includes a user, an owner, a consumer, and a service provider. The user may use a third-party Web service and also has an account in the service provider. Like the user, the owner has an account in the service provider, and provides a resource to the consumer. The consumer is a Web site or an application accessing the service provider in place of the user. The service provider is a Web server or Web application permitting access through OAuth. The service provider authenticates all of the user, the owner, and the consumer. In some cases, all users may play a role of the owner, and are authenticated by a combination of a user_id and user_secret registered to the service provider. The consumer is a subject having a Web API license, and is authenticated by a consumer_id and consumer_secret registered to the service provider.

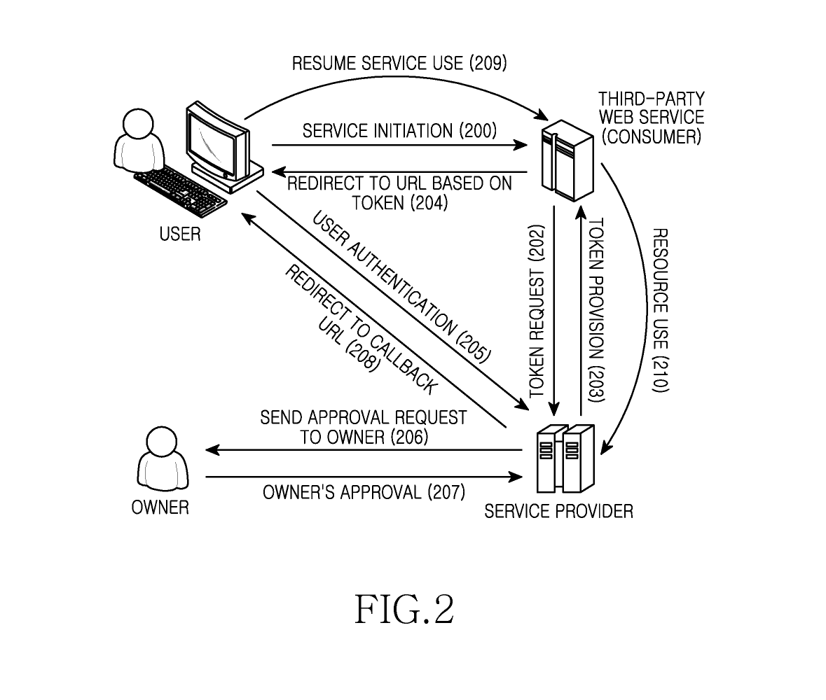

FIG. 2 illustrates an authentication procedure, according to an embodiment of the present invention.

Referring to FIG. 2, in step 200, a user has an account in a service provider and has access to a third-party (i.e., a consumer) Web service. The user does not need to provide any information related to the service provider, to the third-party Web service.

For example, in step 200, the user has an account in the service provider (e.g., a social networking site) beforehand, and has access to a new Web service consumer. The consumer is assumed to provide a function of sending gifts to social networking friends of the user or an owner related to the user.

In step 202, the consumer sends a request for issuance of a token for API use to the service provider so as to use a resource (e.g., a list of friends) of the user or the owner related to the user. The consumer provides a consumer_id and consumer_secret in an encrypted form to the service provider so that the service provider may authenticate the consumer. For example, the consumer informs the service provider to which degree the consumer will access the resource for the user registered to the service provider and the owner. The consumer specifies a use range and condition of an API that he/she intends to use himself/herself. If necessary, the service provider may provide a callback Uniform Resource Locator (URL) to the user so that the user may resume service use after authentication completion.

In step 203, the service provider authenticates the consumer and issues a token. The token is in a state of being approved by one of the user and the owner, so the consumer may not yet use the resource using the token. If the consumer makes a request for resource use with the non-approved token, the service provider responds with an HTTP code 403 (i.e., a Forbidden code).

In step 204, the consumer makes an approval request URL by a combination of the token and an authentication base URL of the service provider and then, redirects a Web page of the user to the approval request URL. The Web page of the user is changed from a third-party Web page of the consumer to an authentication page of the service provider. More specifically, the user does not log into the account of the service provider directly, but the user receives an account URL of the service provider from the consumer, based on the token that the consumer has received from the service provider.

In step 205, the user inputs the user_id and user_secret to the authentication page of the service provider provided from the consumer, and provides the user_id and user_secret in an encrypted form to the service provider. The service provider authenticates the user and then notifies the user of the contents of an API use request related to the token included in the URL (i.e., notifies the user registered to the service provider to which degree the consumer will access the resource for the user registered to the service provider or the owner), and waits for an approval from the user. Although not illustrated, the user confirms and approves the contents of the API use request.

After authenticating the user, the service provider sends a request for approval of the token to the owner and waits for the owner's approval, in step 206. The token approval request includes information about the consumer that makes a request for an initial token, a range and condition of the owner's resource intended to be used, and the user having approved of the token. The token approval request includes a URL for receiving the owner's approval or non-approval and a response method to the token approval request. For example, the token approval request to the owner may be a method using a non-real-time approval channel, through which it is difficult to expect prompt approval, such as an electronic mail (e-mail) and the like, or a method using a real-time approval channel capable of expecting prompt approval, such as a Short Message Service (SMS), a dedicated notification channel, and the like. The channel may be selected in advance and registered by the owner. However, for the non-real-time channel, step 208 may be performed before step 207.

In step 207, the owner confirms the token approval request from the service provider and, according to the response method included in the token approval request, the owner transmits approval or non-approval to the service provider. The owner may specify a new range and condition revising and limiting the use range and condition of the owner's resource first requested by the consumer.

In step 208, when the owner's approval request channel selected in step 206 is a real-time channel, the service provider may automatically convert the Web page of the user into the Web page of the consumer, based on the callback URL received at the time of the consumer's token request of step 202. When the owner's approval request channel is the real-time channel after user approval (in step 205), the service provider may just provide the callback URL to the user, irrespective of the owner's approval, in step 207.

In step 209, the user resumes the use of the service provided by the consumer using the callback URL provided from the service provider. This is accomplished automatically when the service provider provides the callback URL to the user, in step 208. Otherwise, after the lapse of a constant time, the user may resume the use of the service provided by the consumer himself/herself.

In step 210, the consumer attempts resource use using the token issued in step 203. The attempt succeeds only when the token is approved by all of the user and the consumer.

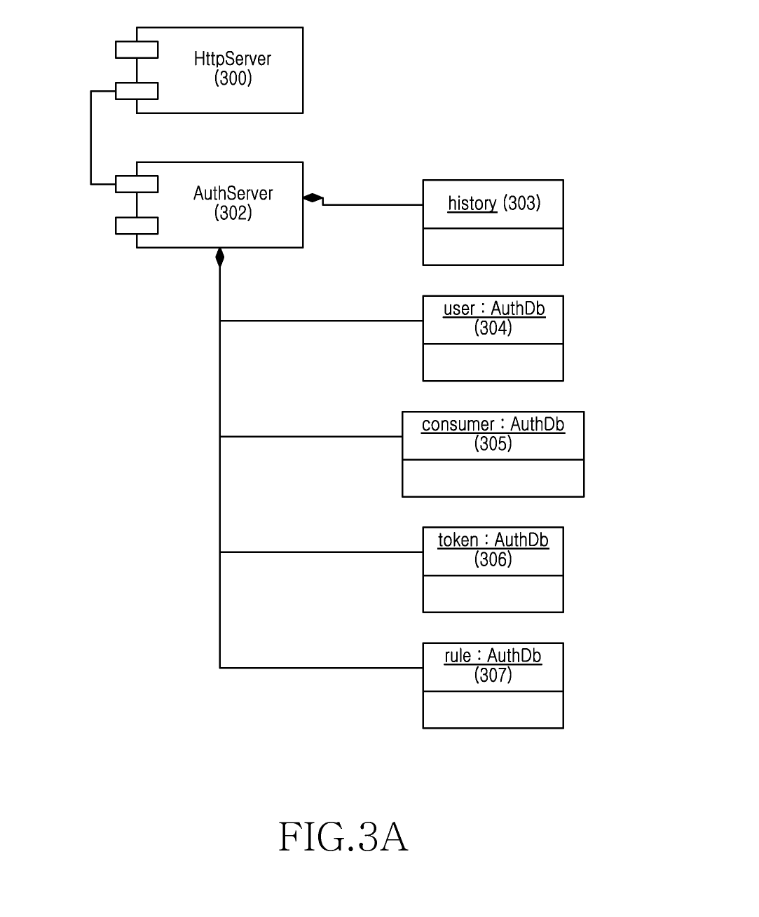

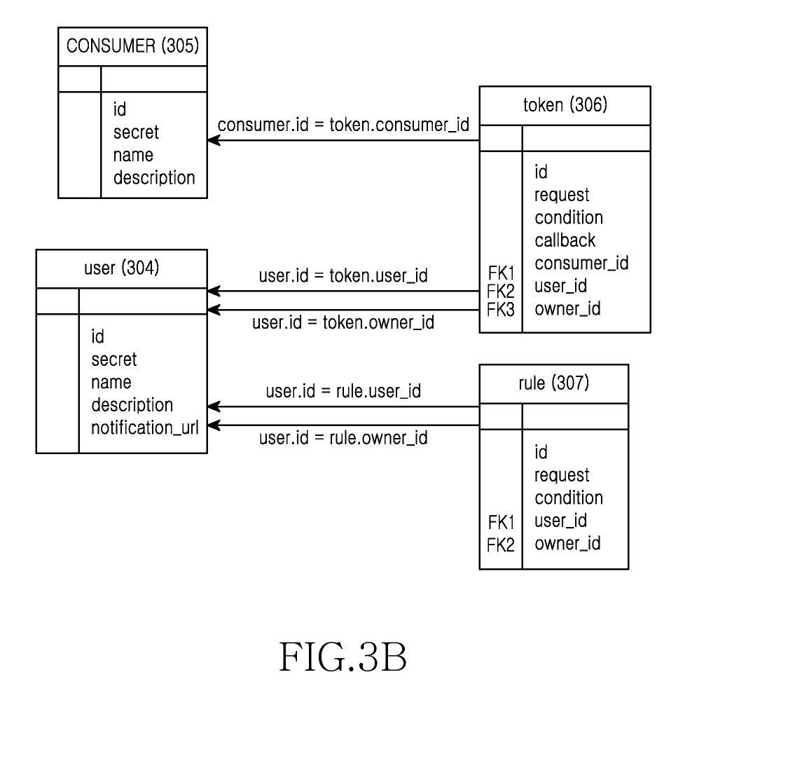

FIG. 3A illustrates a service provider structure, according to an embodiment of the present invention.

Referring to FIG. 3A, if a service provider receives a user or consumer's Web request, an HttpServer 300 processes the Web request. If a pattern of the Web request matches with a registered pattern of an AuthServer 302, the HttpServer 300 executes the AuthServer 302. The AuthServer 302 has a database ‘AuthDb’ 304, 305, 306 storing user, consumer, and token information, so the AuthServer 302 may check authentication elements included in the Web request. Also, the AuthServer 302 stores a token request history 303 of a constant period of time in a history so that it may filter a duplicated request. The token request history is used when the service provider issues a token to the consumer at a time the consumer makes a request for a token to the service provider. A rule table 307 contains a rule in which a resource owner permits its own specific resource for a specific user, thus, enabling the service provider to approve, instead of the owner, by omitting an owner's approval step in a protocol execution process.

FIG. 3B illustrates a table structure of the AuthDb of FIG. 3A, according to an embodiment of the present invention.

Referring to FIG. 3B, a consumer AuthDb 305 includes a consumer's identification (id), secret, name, and description. A user AuthDb 304 includes a user or owner's id, secret, name, description, and notification_url. The notification_url is Uniform Resource Locator (URL) information for receiving the owner's approval or non-approval. A token AuthDb 306 is related to the consumer's AuthDb 305 and the user's AuthDb 304. A rule AuthDb 307 is related to the user AuthDb 304. The user AuthDb 304 is related to all of the token AuthDb 306 and the rule AuthDb 307.

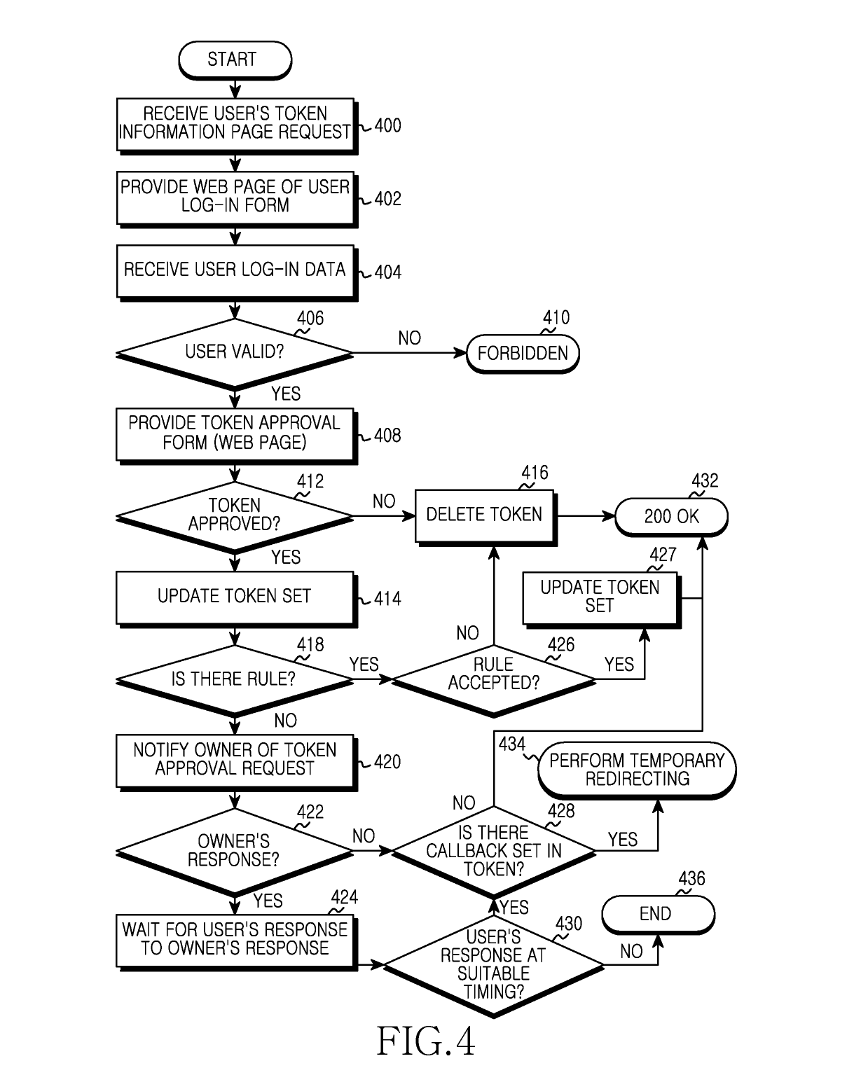

FIG. 4 illustrates a token check procedure between a service provider and a user, according to an embodiment of the present invention. After issuing a token, the service provider gets ready to process a user's token check page request. The user's token check is commonly initiated by the consumer's redirecting. At the time of user's token check request, steps 205 to 208 of FIG. 2 are performed.

Referring to FIG. 4, in step 400, the service provider receives a user's token information page request from a user. For example, the user may approve or reject a token in a token information page as set forth below.

[signing request for user]

<html>
<body>

<p>

someapp is trying to get tom's /resource
under your name. Would you ask tom for
approval

</p>
<form>

<input type=“button” value=“Yes”>
<input type=“button” value=“No”>

</form>
<p>

Or, <a href=“/user-report/3abf-228e-
a3c569e2”>report</a> this as abusive.

</p>

</body>
</html>

In step 402, the service provider provides a Web page of a user log-in form to the user through a consumer. In step 404, the service provider receives user log-in information from the user. The Web page of the user log-in form is generated by the consumer through a combination of a token issued by the service provider and an authentication base URL of the service provider.

In step 406, the service provider determines if the user is valid based on the user log-in information received from the user.

If it is determined in step 406 that the user is invalid, the service provider proceeds to step 410 and informs the user that it is “Forbidden”. Specifically, the service provider informs the user that the token is invalid.

If it is determined in step 406 that the user is valid, the service provider proceeds to step 408 and provides the user with the contents of an API use request related to the token. Specifically, the service provider authenticates the user and then notifies the user of the contents of the API use request related to the token included in the URL. For example, the service provider notifies the user registered to the social networking site to which degree the consumer will access a resource for the user registered to the social networking site. The service provider then waits for the user's approval.

In step 412 it is determined whether the token is approved. If it is determined that the token is not approved by the user, that is, the user does not license an authority realm in which the consumer may access a user's resource though the service provider, the service provider proceeds to step 416 and deletes the non-approved token, and, in step 432, transmits a 200 OK code to the user.

In contrast, if it is determined in step 412 that the token is approved by the user, that is, the user licenses the authority realm in which the consumer may access the user's resource through the service provider, the service provider proceeds to step 414 and updates a token set.

The service provider proceeds to step 418 and determines whether there is a rule. Specifically, the service provider determines whether a rule has been defined in which a resource owner permits its own specific resource for a specific user. For example, the resource owner may omit a token approval procedure, when it is determined that there is no need for the token approval procedure for a specific user.

If it is determined that there is the rule in step 418, the service provider proceeds to step 426 and determines whether the rule is accepted. If the rule is not accepted, the service provider deletes the corresponding token, in step 416. If the rule is accepted, the service provider updates the token set, in step 427. Specifically, the service provider adds the corresponding token to the token set. After steps 416 and 427, the methodology proceeds to step 432 where the 200 OK code is transmitted to the user.

If it is determined that there is no rule in step 418, the service provider proceeds to step 420 and notifies the owner of the token approval request in real-time or non-real-time.

In step 422, the service provider determines whether there is a response to the token approval request, from the owner. If it is determined that there is a response to the token approval request, the service provider proceeds to step 424 and waits for a user's response to the owner's token approval response. In step 430, it is determined whether the user's response is received at a suitable time. If it is determined that the user's response is not received at a suitable time, the service provider terminates the procedure, in step 436. If it is determined that the user's response is received at a suitable time, the service provider proceeds to step 428.

Similarly, if it is determined that there is no owner's response to the token approval request in step 422, the service provider proceeds to step 428. In step 428, the service provider determines whether there is a callback set in the token. If it is determined that there is not a callback set in the token, the service provider proceeds to step 432, where the 200 OK code is transmitted to the user. If it is determined in step 428 that there is a callback set in the token, the service provider proceeds to step 434 and performs temporary redirecting.

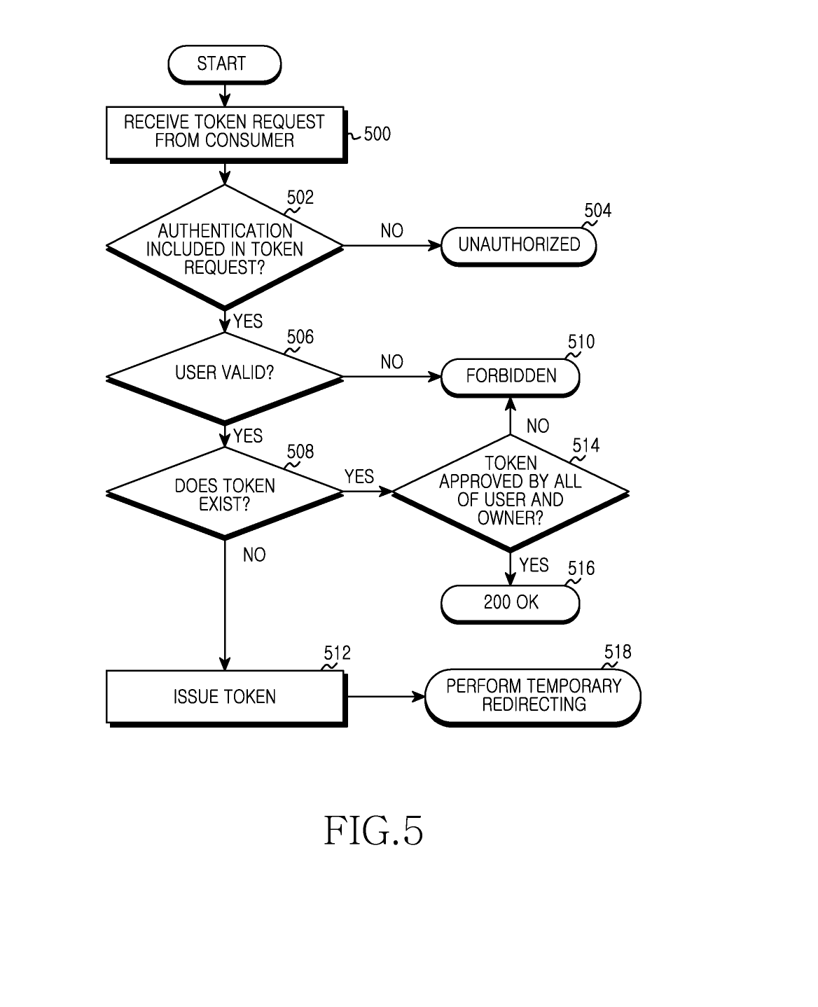

FIG. 5 illustrates a token issuance procedure between a consumer and a service provider, according to an embodiment of the present invention. The token issuance procedure between the consumer and the service provider is a detailed description of steps 202 and 203 of FIG. 2.

Referring to FIG. 5, in step 500, the service provider receives a token request from the consumer. In step 502, the service provider determines if authentication has been included in the token request. Specifically, in step 502, the service provider identifies if consumer_id and consumer_secret information have been included in the token request.

If it is determined that the authentication has not been included in the token request, the service provider proceeds to step 504 and informs the consumer that the token request is “unauthorized”.

For example, a response of the service provider to the unauthorized token request of the consumer is provided below.

[request]

GET /resource HTTP/1.1
Host: tom.example.com

[response]

HTTP/1.1 401 Unauthorized
WWW-Authenticate: wauth realm=“tom”

In contrast, when it is determined that the authentication is included in the token request, the service provider proceeds to step 506 and determines if a consumer_id and consumer_secret of the consumer are valid.

If it is determined that the consumer_id and consumer_secret of the consumer are invalid, the service provider proceeds to step 510 and informs the consumer that it is “Forbidden”.

In contrast, if it is determined in step 506 that the consumer_id and consumer_secret of the consumer are valid, the service provider proceeds to step 508 and determines if a token exits for the consumer. The service provider determines the existence or non-existence of the token for the consumer because a token may already be issued and used by the consumer before the user accesses a Web site provided by the consumer.

If it is determined that the token does not exist in step 508, the service provider proceeds to step 512 and issues a token for the consumer. The service provider performs temporary redirecting, in step 518. Specifically, the service provider redirects to a temporary URL after the token issuance.

In contrast, if it is determined that the token exists in step 508, the service provider determines whether the already issued token has been approved by both of the user and the owner. If it is determined that the already issued token has been approved by both of the user and the owner, the service provider transmits a 200 OK code, in step 516. If it is determined that the already issued token has not been approved by either the user or the owner, the service provider informs the consumer that it is “Forbidden”, in step 510.

Specifically, in the token issuance step, the service provider creates entry and records request, condition, callback and consumer id information in a token table. The service provider creates a redirection URL using the token, and the service provider leads the temporary redirecting.

For example, a redirecting response of the service provider to the token request of the consumer is provided below.

[request]

GET /resource HTTP/1.1
Host: tom.example.com
Authorization: wauth realm =“tom”,

consumer_id=“someapp”,
signature_method=“HMAC-SHA1”,
signature=“xeg010ggkc121b.?”,
callback=“http://someapp.com/”,
condition =“forever”

[response]

HTTP/1.1 307 Temporary Redirect
Location: http://auth.example.com/token/3abf-

228e-a3c569e2

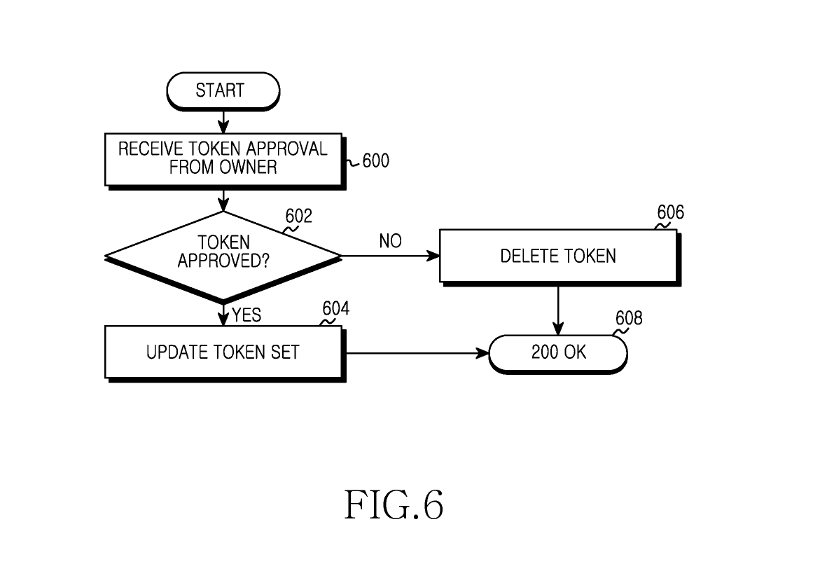

FIG. 6 illustrates a token approval procedure between a service provider and an owner, according to an embodiment of the present invention. The token approval procedure between the service provider and the owner is performed in steps 206 and 207 of FIG. 2.

Referring to FIG. 6, in step 600, the service provider receives a token approval from the owner (step 207 of FIG. 2).

In step 602, the service provider determines whether the received token is an approved token. If the token is an approved token, the service provider updates a token set, in step 604. The service provider then transmits a 200 OK code, in step 608.

In contrast, if the token is a non-approved token, the service provider deletes the token in a database, in step 606. The service provider then transmits a 200 OK code, in step 608.

As described above, embodiments of the present invention have the advantage of being capable of more safely realizing various social scenarios than in a Web, by providing a Web security protocol enabling several users to make safe use of a shared resource and a service provider structure supporting this protocol.

While the invention has been shown and described with reference to certain embodiments thereof, it will be understood by those skilled in the art that various changes in form and details may be made therein without departing from the spirit and scope of the invention as defined by the appended claims.

What is claimed is:

1. A method for authentication in a Web server, the method comprising the steps of:
receiving a token request from a third-party Web server;
authenticating the third-party Web server;
issuing a token to the third-party Web server;
authenticating a user based on the token issued to the third-party Web server;
sending a token approval request to a resource owner; and
receiving a token approval or non-approval from the resource owner through a predefined channel.

2. The method of claim 1, further comprising providing a callback Uniform Resource Locator (URL) to the user.

3. The method of claim 1, wherein receiving the token request from the third-party Web server comprises receiving one or more of an IDentification (ID) and a password of the third-party Web server, a resource use range and condition for the third-party Web server, and a callback URL to which the user will redirect after the user authentication.

4. The method of claim 1, wherein sending the token approval request to the resource owner through the predefined channel comprises:
forwarding, to the resource owner, information on the third-party Web server, information on a range and condition of a resource that the third-party Web server intends to use, and information on the user, information on a URL capable of identifying the token approval or non-approval from the resource owner, and information on a response method to the token approval request;
wherein the predefined channel comprises one of electronic mail (e-mail), a Short Message Service (SMS), and a dedicated notification channel.

5. The method of claim 1, wherein authenticating the user based on the token issued to the third-party Web server comprises:
receiving a token information page request from the user;
providing a log-in page to the user and receiving user log-in data from the user through the third party Web server;
inquiring, of the user, about whether to approve the token, when the user log-in data is valid; and
receiving token approval from the user.

6. The method of claim 1, wherein receiving the token approval or non-approval from the resource owner comprises:
notifying the resource owner of the token approval request through the predefined channel; and
determining whether there is a response to notification of the token approval request;
waiting for the token approval or non-approval for a predefined period, when there is the response to the notification of the token approval request.

7. The method of claim 6, further comprising, determining whether there is a callback URL and redirecting to the callback URL, when there is no response to the notification of the token approval request.

8. The method of claim 6, further comprising, determining whether there is a callback URL and redirecting to the callback URL, when the token approval or non-approval is not received within the predefined period.

9. The method of claim 1, further comprising, after authenticating the user, determining whether a rule exists and determining whether to perform a token approval procedure of the resource owner.

10. A method for authentication in a third-party Web server, the method comprising the steps of:
receiving a service request from a Web-based user terminal;
sending a token request to a Web server in which a user has an account;
receiving an issued token from the Web server;
creating an authentication Uniform Resource Locator (URL) of the Web server based on the issued token; and
redirecting the user to the authentication URL of the Web server.

11. The method of claim 10, wherein sending the token request to the Web server in which the user has the account comprises forwarding one or more of an IDentification (ID) and password of the third-party Web server, a resource use range and condition for the third-party Web server, and a callback URL to which the user will redirect after user authentication.

12. A method for authentication in a user terminal, the method comprising the steps of:
accessing a third-party Web server for service initiation;
redirecting from the third-party Web server to an authentication URL of a Web server in which a user has an account;
receiving a log-in page from the Web server;
forwarding user log-in data to the Web server; and
when the user log-in data is valid, receiving an inquiry about whether to approve a token from the Web server, and determining token approval.

13. The method of claim 12, further comprising receiving a callback URL from the Web server, and redirecting to the callback URL.

14. A method for authentication in an owner terminal, the method comprising the steps of:
receiving a token approval request notification through a predefined channel from a Web server in which an owner has an account, when a resource of the owner is requested by a third-party Web server;
checking a license to the resource that is requested by the third-party Web server; and
transmitting a response to the token approval request, to the Web server, based on the license to the resource.

15. The method of claim 14, further comprising changing contents of the license to the resource that is requested by the third-party Web server, and transmitting the changed contents to the Web server.

16. The method of claim 14, wherein receiving the token approval request notification from the Web server through the predefined channel comprises:
receiving information on the third-party Web server, information on a range and condition of a resource that the third-party Web server intends to use, and information on a user having approved of the token, information on a Uniform Resource Locator (URL) capable of identifying token approval or non-approval of the owner, and information on a response method to the token approval request notification;
wherein the predefined channel comprises one of electronic mail (e-mail), a Short Message Service (SMS), and a dedicated notification channel.

17. A system for authentication comprising:
a subscriber terminal for accessing a third-party Web server for service initiation via a service request, redirecting from the third party Web server to an authentication Uniform Resource Locator (URL) of a Web server in which a user has an account, performing authentication, receiving an inquiry about whether to approve a token from the Web server, and determining token approval;
the third-party Web server for receiving the service request from the user terminal, sending a token request to the Web server, receiving an issued token from the Web server, creating the authentication URL of the Web server based on the issued token, and redirecting the user terminal to the authentication URL of the Web server;
the Web server for receiving the token request, authenticating the third-party Web server, issuing the token to the third-party Web server, authenticating the user based on the token issued to the third-party Web server, sending a token approval request to a resource owner terminal through a predefined channel, and receiving a token approval or non-approval from the resource owner terminal; and
the resource owner terminal for receiving a token approval request notification through the predefined channel from the Web server, checking a license to a resource requested by the third-party Web server, and transmitting the token approval or non-approval to the Web server in response to the token approval request.

18. The system of claim 17, wherein the Web server provides a callback URL to the user.

19. The system of claim 17, wherein receiving the token request at the Web server from the third-party Web server comprises:
receiving one or more of an IDentification (ID) and password of the third-party Web server, a resource use range and condition for the third-party Web server, and a callback URL to which the user will redirect after authenticating the user.

20. The system of claim 17, wherein sending the token approval request from the Web server to the resource owner terminal through the predefined channel comprises:
forwarding, to the resource owner terminal, information on the third-party Web server, information on a range and condition of a resource that the third-party Web server intends to use, information on the user, information on a URL capable of identifying the token approval or non-approval of the resource owner terminal, and information on a response method to the token approval request;
wherein the predefined channel comprises one of electronic mail (e-mail), a Short Message Service (SMS), and a dedicated notification channel.

21. The system of claim 17, wherein the Web server:
receives a token information page request from the user,
provides a log-in page to the user and receives user log-in data from the user, through the third-party Web server,
inquires, of the user, about whether to approve the token, when the user log-in data is valid, and
receives token approval from the user.

22. The system of claim 17, wherein the Web server:
notifies the resource owner terminal of the token approval request, through the predefined channel,
determines whether there is a response to the token approval request notification; and
waits for the token approval or non-approval for a predefined period, when there is the response to the notification of the token approval request.

23. The system of claim 22, wherein, when there is no response to the token approval request notification, the Web server determines whether there is a callback URL and redirects to the callback URL.

24. The system of claim 22, wherein, when the token approval or non-approval is not received within the predefined period, the Web server determines if there is a callback URL and redirects to the callback URL.

25. The system of claim 17, wherein, after authenticating the user, the Web server determines whether a rule exists and determines whether to perform a token approval procedure of the resource owner terminal.

26. The system of claim 17, wherein the user resource terminal receives a callback URL from the Web server, and redirects to the callback URL.

27. The system of claim 17, wherein the resource owner terminal changes contents of the license to the resource that is requested by the third-party Web server and transmits changed contents to the Web server.
